(19) United States
(12) Patent Application Publication
(10) Pub. No.: US 2026/0014660 A1
(43) Pub. Date: Jan. 15, 2026

(54) INTEGRATED CUTTING TOOL SHARPENING SYSTEM

(71) Applicant: Marvin G. BOWEN, SR., White Plains, NY (US)

(72) Inventor: Marvin G. BOWEN, SR., White Plains, NY (US)

(21) Appl. No.: 19/206,699

(22) Filed: May 13, 2025

Related U.S. Application Data
(60) Provisional application No. 63/731,518, filed on May 13, 2024.
(60) Provisional application No. 63/833,702, filed on Jan. 8, 2025.

(51) Int. Cl. B24B 3/54; B26B 11/00

(52) U.S. Cl. CPC B24B 3/54; B26B 11/00

(57) ABSTRACT

An integrated cutting tool sharpening system includes a blade, a guiding channel disposed along at least one side face of the blade, and a bifurcated handle. The bifurcated handle includes a first handle member fixed to the base of the blade and a second handle member removably coupled to the first handle member. The second handle member slides along the blade after the second handle member is released from the first handle member. The second handle member includes a blade sharpener to sharpen a cutting edge of the blade and a guiding pin slidably received in the guiding channel. The system includes a locking mechanism to releasably secure the second handle member to the first outer casing.

### CROSS-REFERENCE TO RELATED APPLICATIONS

This application claims priority to U.S. Provisional Patent Application No. 63/731,518 filed on May 13, 2024 and U.S. Provisional Patent Application 63/833,702, filed on Jan. 8, 2025, which are incorporated by reference herein in their entirety for all purposes.

### FIELD

The present disclosure relates to an integrated cutting tool sharpening system.

### BACKGROUND

Cutting tools, such as knives, machetes, and other handheld bladed devices, are prone to losing sharpness over the course of use. These cutting tools require sharpening tools to maintain or regain an adequate level of sharpness. Cutting tools with an adequate sharpness allows for greater ease of cutting and improved user safety. A wide variety of conventional sharpening mechanisms complement these cutting tools to maintain blade sharpness.

However, conventional sharpening mechanisms used for maintaining cutting tool sharpness are implemented externally to the cutting tool. In other words, conventional sharpening mechanisms are generally external structures that are separate and distinct from the cutting tool itself. For example, conventional sharpening mechanisms are regularly manufactured, packaged, and sold separately from the cutting tool they are designed to sharpen. Furthermore, the manufacturers of cutting tools and sharpeners do not entirely overlap. A consumer may need to purchase a cutting tool from one particular manufacturer and a sharpening tool from another manufacturer. This bifurcated purchasing process is frustrating for consumers.

Additionally, some sharpeners cannot not be used with particular cutting tools. For example, different types of kitchen knives benefit from different sharpening mechanisms. A butcher knife may benefit from a specialized sharpener designed to match the contours of the butcher knife. Conversely, a serrated kitchen knife may benefit from a different type of specialized sharpener to sharpen the serrated knife edge. Furthermore, the one type of sharpening mechanism may be more appropriate for a particular cutting tool based on the shape of the blade. For example, a straight blade cutting tool, like a box cutter, may require a sharpening mechanism different than a curved blade cutting tool, like a machete.

Moreover, some sharpening tools require a particular expertise in using the cutting tool itself. An external sharpening mechanism may require advanced training in using a particular cutting tool that the average consumer does not have. For example, a whetstone may require expertise in using culinary cutting tools. Without such expertise, a user is more prone to injury and damaging the cutting tool.

Thus, existing sharpening mechanisms have a limited ability to both consistently maintain the sharpness of a cutting tool and be easy to use. Many conventional sharpening mechanisms also force consumers to purchase additional sharpening supplies and/or require an advanced cutting tool skillset to reduce the risk of injury. Therefore, there is a growing demand for sharpening systems that provide consistent sharpness, simplicity to use, and a streamlined purchasing process.

### SUMMARY

The present disclosure provides a system for an integrated cutting tool sharpener. The system includes a blade, a guiding channel, and a bifurcated handle. In some aspects, the bifurcated handle includes a first handle member, a second handle member, and a locking mechanism.

In some aspects, the blade includes a cutting edge, a base, a tip, a first side face, and a second side face.

In some aspects, the guiding channel may be disposed along at least one side of the first side face or the second side face.

In some aspects, the bifurcated handle may include a first handle member fixed to the base of the blade. The first handle member may additionally include a first outer casing and a connecting shaft(s) securing the first outer casing to the blade.

In some aspects, the bifurcated handle may include a second handle member removably coupled to the first handle member. The second handle member may be configured to slide along the blade from a first position to a second position. In some aspects, the second handle member may include a second outer casing, a blade sharpener, and a guiding pin.

In some aspects, the blade sharpener of the second handle member is disposed at a top portion of the second handle member. The blade sharpener may be configured to engage the cutting edge of the blade as the second handle member slides along the blade.

In some aspects, the guiding pin may be coupled to the second outer casing and slidably received in the guiding channel such that the guiding pin is configured to slide along the guiding channel as the second handle member slides along the cutting edge of the blade.

In some aspects, the bifurcated handle may include a locking mechanism disposed on at least one of the first outer casing or the second outer casing. The locking mechanism may be configured to releasably secure the second outer casing of the second handle member to the first outer casing of the first handle member, or vice versa.

In some aspects, the blade sharpener may include a first sharpening blade and a second sharpening blade opposing the first sharpening blade. The first sharpening blade and the second sharpening blade are arranged to receive the cutting edge of the blade between the first sharpening blade and the second sharpening blade. The blade sharpener may additionally include one or more sharpening springs corresponding to the first sharpening blade and the second sharpening blade. The sharpening springs may bias the first sharpening blade and/or the second sharpening blade towards each other.

In some aspects, the blade sharpener may additionally include a housing received inside of the second outer casing. In such aspects, the first sharpening blade, the second sharpening blade, and the one or more sharpening springs are received inside of the housing. Therefore, the one or more sharpening springs may be engaged against a wall of the housing and the backside of at least one of the first sharpening blade or the second sharpening blade.

In some aspects, the guiding channel may be disposed along at least one of the first side face and the second side face of the blade. In some aspects, the guiding channel may be an opening extending through the first side face and the second side face of the blade. In some other aspects, the guiding channel may define a first concave groove disposed along the first side face of the blade and a second concave groove disposed along the second side face of the blade.

In some aspects, the cutting edge of the blade may be straight and the guiding channel may extend from the base of the blade to the tip of the blade.

In some aspects, the bifurcated handle may include a first handle lip on a top portion of the second handle member adjacent to the blade and a second handle lip on a bottom portion of the second handle member.

In some aspects, the locking mechanism may be disposed at a proximal end of the first handle member. The locking mechanism may further include a spring disposed in the first outer casing. The spring is configured to release the second handle member coupled to the first handle member in response to receiving an application of force. The locking mechanism may additionally include a sliding component disposed at the proximal end of the first handle member. The sliding component is configured to slide from a resting position along the proximal end of the first handle member, thereby applying the force on the spring to release the second outer casing of the second handle member from the first outer casing of the first handle member.

In some aspects, the locking mechanism may be disposed between the bottom portion and the top portion of the bifurcated handle, such as the second handle member. The locking mechanism may be configured to release the second handle member coupled to the first handle member based on receiving an application of force. The locking mechanism may also include a button disposed between the bottom portion and the top portion of the second handle member. The button may apply the force on the spring after being pressed, thereby uncoupling of the second handle member from the first handle member.

In some aspects, the cutting edge of the blade may be curved and shape of the guiding channel may reflect the curvature of the cutting edge and continue to the tip of the blade.

In some aspects, the second handle member may include an automated sharpening system that is disposed inside of the second outer casing. The automated sharpening system may include a battery and a motor configured to receive power from the battery. The motor may propel the second handle member to slide between a first position (e.g., a base of the blade) and a second position (e.g., a tip of the blade).

In some aspects, the automated sharpening system may include a controller in electrical communication with the battery and a power button in electrical communication with the controller. The controller may refer to a microcontroller. Each component of the automated sharpening system may be releasably secured within an electrical housing.

In some aspects, the power button may comprise a transducer configured to initiate the transmission of power between the battery and the motor.

In some aspects, the motor may be configured to propel the second handle to slide at a predetermined speed along the guiding channel from the first position to the second position. In some aspects, the motor may be configured to propel the second handle member to slide at the predetermined speed in a reverse direction from the second position to the first position. The first position may refer to the base of the blade. The second position may refer to the tip of the blade. In some aspects, the motor may be configured to propel the second handle member in a reverse direction based on a determination that the guiding pin of the second handle member has reached the end of the guiding track.

In some aspects, a component of the blade sharpener, such as the sharpening blade, may comprise a particular material. For example, the particular material may be tungsten steel. The blade sharpener may also include one or more sharpening stones. The sharpening stones may be one or more diamond-coated stones with a predetermined grit size and a predetermined orientation with respect to the cutting edge of the blade. For example, the pre-determined grit size may range from 200 grit to 1000 grit.

In some aspects, the second handle member may be configured to pivot about an axis, defined by the guiding pin, to a sliding position. The sliding position may refer to an instance in which the second handle member extends perpendicularly with respect to the first handle member.

In some aspects, the sliding position may refer to an instance in which the second handle member is uncoupled with the first handle member and may slide parallel to the blade. The safety pin may be configured to lock the second handle member at a predetermined orientation from the first handle member. In some aspects, the safety pin may be the guiding pin.

In some aspects, a safety pin within the second handle member may be configured to lock the second handle member at the sliding position.

### BRIEF DESCRIPTION OF THE FIGURES

The accompanying drawings, which are incorporated herein and form part of the specification, illustrate aspects and, together with the description, further serve to explain the principles of the aspects and to enable a person skilled in the art to make and use the aspects.

FIG. 1A illustrates a side view of an integrated cutting tool sharpening system with a curve-bladed cutting tool and a bifurcated handle implemented on the curve-bladed cutting tool, according to some aspects.

FIG. 1B illustrates a top view of the integrated cutting tool sharpening system with the curve-bladed cutting tool and the bifurcated handle implemented on the curve-bladed cutting tool, according to some aspects.

FIG. 2 illustrates a side view of the integrated cutting tool sharpening system with the curve-bladed cutting tool and the bifurcated handle implemented on the curve-bladed cutting tool, according to some aspects.

FIG. 3 illustrates an enlarged isometric view of an integrated cutting tool sharpening system with a releasable sharpener removed from the bifurcated handle, according to some aspects.

FIG. 4A illustrates a perspective view of an integrated cutting tool sharpening system implemented on a straight-bladed cutting tool, according to some aspects.

FIG. 4B illustrates a schematic diagram of a back view of the integrated cutting tool sharpening system implemented on the straight-bladed cutting tool, according to some aspects.

FIG. 5 illustrates a side view of the integrated cutting tool implemented on a straight-bladed cutting tool, according to some aspects.

FIG. 6 illustrates a schematic diagram of an automated sharpening system disposed within an integrated cutting tool sharpening system, according to some aspects.

The features and advantages of the aspects will become more apparent from the Detailed Description set forth below when taken in conjunction with the drawings. A person of ordinary skill in the art will recognize that the drawings may use different reference numbers for identical, functionally similar, and/or structurally similar elements, and that different reference numbers do not necessarily indicate distinct aspects or elements. Likewise, a person of ordinary skill in the art will recognize that functionalities described with respect to one element are equally applicable to functionally similar, and/or structurally similar elements.

### DETAILED DESCRIPTION

Aspects of the present disclosure are described in detail with reference to aspects thereof as illustrated in the accompanying drawings. References to “one aspect,” “an aspect,” “some aspects,” “certain aspects,” etc., indicate that the aspect described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

For the purposes of this disclosure, the term “member” may include one, or more than one, component within an actual device, apparatus, or system, and each component that forms a part of the described member may function either cooperatively or independently of any other component forming a part of the member. Conversely, multiple members described herein may represent a single component within an actual deice, system, or apparatus. Further, components within a member may be in a single device, apparatus, or system or distributed among multiple in a wired or wireless manner.

The following Detailed Description of the exemplary aspects will so fully reveal the general nature of the disclosure so that others can, by applying knowledge of those skilled in the relevant art, readily modify and/or add for various applications such exemplary aspects, without undue experimentation, without departing from the spirit and scope of the disclosure. Therefore, such adaptations and modifications are intended to be within the meaning and plurality of equivalents of the exemplary aspects based upon the teaching and guidance presented herein. It is to be understood that the terminology herein is for the purpose of description and not of limitation, such that the terminology of the present specification is to be interpreted by those skilled in the relevant art in light of the teachings herein.

Conventional sharpening mechanisms, structures, or other manufactures are separate and distinct from the cutting tool. Furthermore, manufacturers of cutting tools and sharpeners do not generally overlap. A consumer may need to buy a cutting tool from one manufacturer and a sharpening tool from another manufacturer. This bifurcated commercial process may be frustrating for consumers.

Additionally, some sharpeners may not apply to every cutting tool. For example, different types of kitchen knives may benefit from different sharpening mechanisms. Moreover, a straight bladed cutting tool may require a sharpening mechanism different than a curve bladed cutting tool.

The expertise required to use some sharpeners adds additional complexity to conventional sharpening mechanisms. Some external cutting tool sharpeners may require advanced training with the cutting tool itself that many consumers do not have. For example, a whetstone may require expertise in using culinary cutting tools. Without such expertise, a user may be prone to further damaging the cutting tool or themselves.

Accordingly, there is a growing demand for systems that provide consistent sharpening quality, are easy to use, and streamline the bifurcated process of purchasing both cutting tools and their corresponding external sharpeners.

Provided herein are a system, apparatus, device, and/or method aspects and/or combinations and sub-combinations thereof, for an integrated cutting tool sharpener. A consumer may not be skilled enough nor have the resources necessary to purchase and use a variety of cutting tool sharpeners with their respective cutting tools. For example, many external sharpeners put the user at a greater risk of injury if they are not adequately trained in using the cutting tool. Thus, an integrated cutting tool sharpening system both relieves the user of purchasing numerous external sharpening mechanisms and facilitates a safer means of sharpening their cutting tools.

The integrated cutting tool system may include a bifurcated handle, as opposed to the standard singular handle, in conjunction with a blade. The integrated cutting tool system may additionally include a guiding channel on at least one face of the blade. In some aspects, the bifurcated handle may include a first handle member fixed to the blade and a second handle member removably coupled to the first handle member. The bifurcated handle may additionally include a locking mechanism configured to release the second handle member from the first handle member. If the second handle member is released, the second handle member may slide along the blade following the guiding channel.

In some aspects, the second handle member may sharpen an edge of the blade via the blade sharpener disposed in the bifurcated handle. For example, the blade sharpener may be housed inside of the second handle member. The various configurations will be described in further detail below. The following systems are exemplary and are not meant to limit the aspects in any way, as would be appreciated by one skilled in the art.

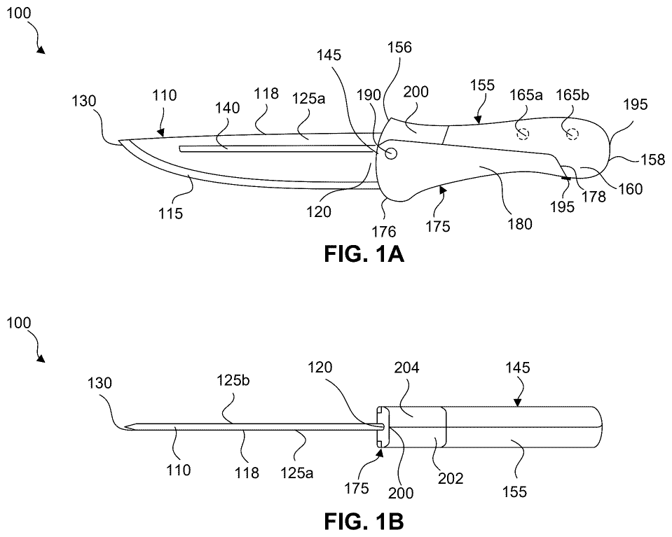

FIGS. 1A-3 illustrate a schematic diagram of an integrated cutting tool sharpening system 100 that includes a curve-bladed cutting tool, such as a blade 110, according to some aspects. Blade 110 may include a cutting edge 115, a top edge 118, a base 120, first side face 125a, second side face 125b, and tip 130. Blade 110 may define a curved blade shape. For example, cutting edge 115 may be curved from base 120 to tip 130. In some aspects, tip 130 of blade 130 may resemble a needle point, drop point, spear point, clip point, trailing point, or any other type of cutting tool tip as would be appreciated by one skilled in the art. Integrated cutting tool sharpening system 100 may include a guiding channel 140 disposed on at least one of first side face 125a and second side face 125b of blade 110. In some aspects, guiding channel 140 may reflect a shape corresponding to the curvature of cutting edge 115 to tip 130. In some aspects, guiding channel 140 may define a straight path without any curvature.

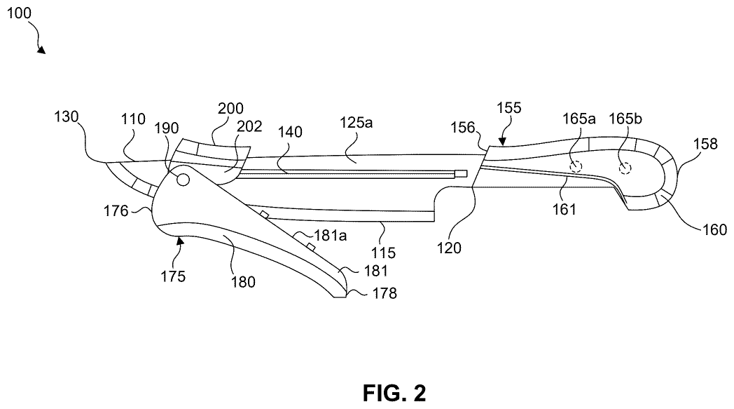

In some aspects, integrated cutting tool sharpening system 100 may include a bifurcated handle 145 implemented on blade 110. For example, bifurcated handle 145 may include a first handle member 155 and a second handle member 175. First handle member 155 may be fixed to base 120 of blade 110. In some aspects, first handle member 155 may include a first outer casing 160. First outer casing 160 may be formed from a rigid material, such as plastic, resin, wood, steel, carbon fiber, titanium, fiberglass, or a comparable material used to form cutting tool handles, as would be appreciated by one skilled in the art. As shown in FIG. 2, first outer casing 160 includes a tapered edge 161 extending from a back portion of first outer casing 160 located at a proximal end 158 of first handle member 155 to a front portion of outer casing 160 located at a distal end 156 of first handle member 155. Tapered edge 161 of first outer casing 160 is configured to engage second handle member 175 when first handle member 155 and second handle member 175 are coupled together. In some aspects, the back portion of outer casing 160 extends entirely around proximal end 158 of first handle member 155. Base 120 of blade 110 may be received through a slot defined in tapered edge 161 of first outer casing 160. First outer casing 160 may include a gasket disposed in the slot receiving base 120 of blade 110 to seal first outer casing 160.

In some aspects, first handle member 155 may include one or more connecting shafts 165a and 165b. For example, connecting shafts 165a and 165b may be disposed inside of first outer casing 160. Connecting shafts 165a and 165b secure first outer casing 160 to blade 110. Connecting shaft 165a may comprise a screw, a pin, or comparable fastener that extends transversely along the width of first outer casing 160 and through blade 110 such that first handle member 155 is fixed to blade 110.

In some aspects, second handle member 175 may include a second outer casing 180, a blade sharpener 185, and a guiding pin 190. Second outer casing 180 may be formed from a rigid material, such as plastic, resin, wood, steel, carbon fiber, titanium, fiberglass, or a comparable material used to form cutting tool handles, as would be appreciated by one skilled in the art.

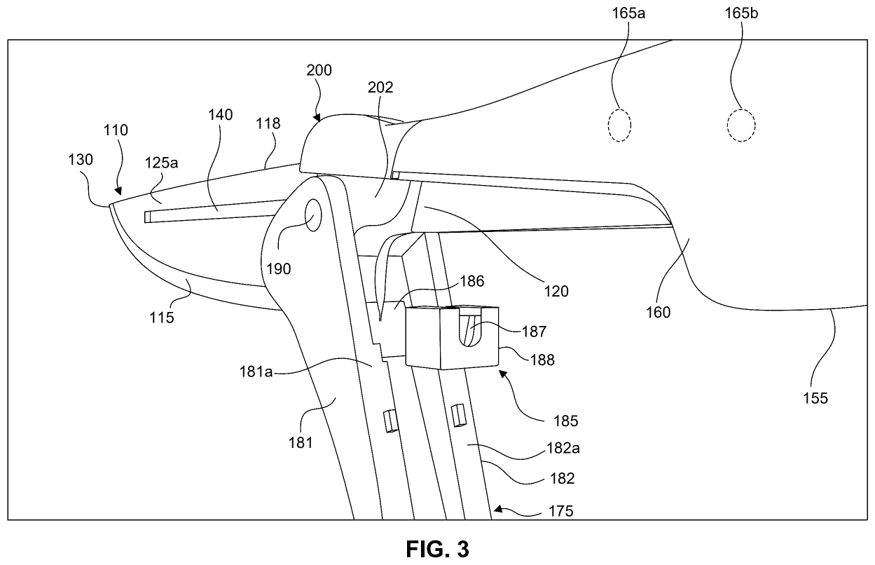

With reference to FIGS. 2 and 3, second outer casing 180 may include a first sidewall 181 received along first side face 125a of blade 110 and a second sidewall 182 received along second side face 125b of blade 110. Cutting edge 115 of blade 110 may be disposed between first sidewall 181 and second sidewall 182 of second outer casing 180 of second handle member 175. In some aspects, first and second sidewalls 181 and 182 of second outer casing 180 may each include an interior edge 181a and 182a configured to engage tapered edge 161 of first outer casing 160 when first handle member 155 is coupled to second handle member 175. Interior edge 181a and 181b of first and second sidewalls 181 and 182 may be flushed against tapered edge 161 of first outer casing 160 when first handle member 155 is coupled to second handle member 175. In some aspects, second outer casing 180 may include a tapered exterior surface 183 extending from a front portion of second outer casing 180 located at distal end 176 of second handle member 175 to a back portion of second outer casing 180 located at a proximal end 178 of second handle member 175. Exterior surface 183 may be grasped by the user when first handle member 155 is coupled to second handle member 175.

In some aspects, second handle member 175 may be removably coupled to first handle member 155. Second handle member 175 may slide along blade 110 from a first position, as shown in FIG. 1A, to a second position, as shown in FIG. 2. The first position may refer to a position in which second handle member 175 is coupled to the first handle member 155. The second position may refer to a position in which second handle member 175 is disposed proximate to tip 130 of blade 110. In some aspects, the second position may refer to any position in which second handle member 175 is disposed on a portion of blade 110 spatially separated from the first position (e.g., at base 120 of blade 110). Since different portions of cutting edge 115 may be more prone to losing sharpness over the course of use, moving second handle member 175 across various positions of cutting edge 115 may target portions of blade 110 that require additional sharpening.

With reference to FIG. 3, blade sharpener 185 may be received in a cavity 186 of second outer casing 180 defined between first sidewall 181 and second sidewall 182. Blade sharpener 185 may include a first sharpening blade 187 and a second sharpening blade opposing first sharpening blade 187. For example, the edges of first sharpening blade 187 and the second sharpening blade may be arranged in a V-shaped formation to receive cutting edge 115 of blade 110 there between. Blade sharpener 185 may include one or more sharpening springs biasing the first sharpening blade 187 and the second sharpening blade towards each other. Furthermore, in some aspects, blade sharpener 185 may include a housing 188 that is received in cavity 186 of second outer casing 180. First sharpening blade 187, the second sharpening blade, and the sharpening spring(s) may be received in housing 188. For example, the sharpening springs may include a first spring engaged against an interior surface of a first wall of housing 188 and a back side of first sharpening blade 187 and a second spring engaged against an interior surface of a second wall of housing 188 and a back side of second sharpening blade, thereby biasing first sharpening blade 187 and the second sharpening blade toward each other. When second handle member 175 is sliding along blade 110, cutting edge 115 of blade 110 is received between first sharpening blade 187 and the second sharpening spring, overcoming the bias of the first and second springs. Pressure applied by the first and second springs urges first sharpening blade 187 and the second sharpening blade in contact with cutting edge 115, thereby sharpening cutting edge 115.

In some aspects, blade sharpener 185 may be composed of a material suitable for sharpening cutting edge 115 of blade 110. For example, first sharpening blade 187 and second sharpening blades of blade sharpener 185 may be composed of tungsten steel or a comparable sharpening material, as would be appreciated by one skilled in the art. In some aspects, blade sharpener 185 may include one or more sharpening stones having a predetermined grit size and orientation with respect to cutting edge 115 of blade 110. The sharpening stones may be diamond-coated stones. The sharpening stones may be implemented within blade sharpener 185 in conjunction with or separately from the sharpening blades. The sharpening stones may have a predetermined grit size selected from a range of grit sizes. For example, the diamond-coated stones of blade sharpener 185 may have a grit size ranging from 200 grit to 1000 grit. In some aspects, the sharpening stones of blade sharpener 185 are arranged to simultaneously perform coarse sharpening, fine sharpening, and refining as the second handle member 175 slides along blade 110.

In some aspects, blade sharpener 185 may be disposed in a front portion of second outer casing 180 located proximate to a distal end 176 of second handle member 175. Blade sharpener 185 may extend from front portion of second outer casing 180 to a back portion of second outer casing 180 located proximate to a proximal end 178 of second handle member 175. In some aspects, blade sharpener 185 may include a first blade sharpener, such as first sharpening blade 187 and the second sharpening blade, located in the front portion of second outer casing 180, and a second blade sharpener, such as the sharpening stones, located adjacent to the first blade sharpener and closer to the proximal end 178 of second handle member 175.

In some aspects, guiding channel 140 may define a concave groove along at least one of first side face 125a and second side face 125b of blade 110. The concave groove of guiding channel 140 may be disposed along first side face 125a, second side face 125b, or a combination thereof. For example, guiding channel 140 may define a first concave groove along first side face 125a and a second concave groove along second side face 125b. In some aspects, guiding channel 140 may define an opening extending through first side face 125a and second side face 125b of blade 110. Guiding channel 140 maintains alignment of second handle member 175 with respect to blade 110 such that cutting edge 115 of blade 110 is received between sharpening blades or stones of a blade sharpener (e.g., blade sharpener 185) housed in second handle member 175 during a sharpening procedure.

In some aspects, guiding pin 190 may be slidably received in guiding channel 140 such that guiding pin 190 may slide along guiding channel 140 as second handle member 175 slides along the blade 110. For example, when implemented with guiding channel 140 defining the first concave groove on first side face 125a and a second concave groove on second side face 125b, guiding pin 190 may include a first pin received in the first concave groove of guiding channel 140 and a second pin received in the second concave groove of guiding channel 140. The first pin of guiding pin 190 may include a first end coupled to first sidewall 181 of second outer casing 180 and a second end received in the first concave groove defined in first side face 125a. The second pin of guiding pin 190 may include a first end coupled to second sidewall 182 of second outer casing 180 and a second end received in the second concave groove defined in second side face 125b. In another example, when implemented with guiding channel 140 defining a hole through first and second side faces 125a and 125b of blade 410, guiding pin 190 may extend transversely through the opening of guiding channel 140 and across the width of second outer casing 180 such that a first end of guiding pin 190 is coupled to first sidewall 181 of second outer casing 180 and a second end of guiding pin 190 is coupled to second sidewall 182 of second outer casing 180. In some aspects, guiding pin 190 may be located proximate to distal end 176 of second handle member 175.

In some aspects, second handle member 175 may include a saddle 200 received over top edge 118 of blade 110 and coupled to a front portion of second outer casing 180. Saddle 200 may include a first sidewall 202 received along first side face 125a of blade 110 and a second sidewall 204 received along second side face 125b of blade 110. Saddle 200 may be coupled to front portion of second outer casing 180 by guiding pin 190 extending through first sidewall 202 of saddle 200 and second sidewall 204 of saddle 200 such that at least a portion of first sidewall 202 is disposed between the first side of second outer casing 180 and first side face 125a of blade 110 and at least a portion of second sidewall 204 is disposed between the second side of second outer casing 180 and second side face 125b of blade 110. Saddle 200 is configured to slide along top edge 118 of blade 110 as second outer casing 180 slides along cutting edge 115

In some aspects, second handle member 175 may be configured to pivot about an axis from the first position, where second handle member 175 is coupled to first handle member 155, to a sliding position, where at least a portion of second handle member 175, such as the back portion of second outer casing 180, is released from first handle member 155. For example, when disposed at the sliding position, second outer casing 180 of second handle member 175 may extend obliquely or perpendicularly with respect to first handle member 155. By pivoting toward a sliding position, the orientation of second outer casing 180 allows a user's hand to be positioned further away from blade 110 and permits the user to apply more force to second outer casing 180 of second handle member 175 during the sharpening process. The axis may be defined by a pin, for example, such as guiding pin 190, received inside second outer casing 180 of second handle member 175. Second handle member 175 may pivot about the axis based on locking mechanism 195 uncoupling second handle member 175 from first handle member 155. When second handle member 175 is set at the sliding position, the user may grasp exterior surface 183 and interior edges 181a and 182a of first and second sidewalls 181 and 182 of outer casing 180.

In some aspects, second handle member 175 may include a safety pin disposed within second outer casing 180. Safety pin may be received in a bore defined in second outer casing 180. Safety pin may be biased, for example, by a spring, to lock second handle member 175 in the sliding position. For example, releasing second handle member 175 from the first position may overcome the biased force acting on the safety pin. Once second handle member 175 reaches a specific perpendicular orientation with respect to first handle member 155 (e.g., the sliding position) and/or blade 110, the safety pin may be biased again to lock second handle member 175 in the sliding position. For example, safety pin may lock second handle member 175 in the sliding position once second handle member 175 pivots 90 degrees, 45 degrees, or any orientation configured by the user, from first handle member 155.

In some aspects, system 100 may include a locking mechanism 195 disposed on at least one of first outer casing 160 of first handle member 155 and second outer casing 180 of second handle member 175. Locking mechanism 195 may be coupled to first handle member 155, second handle member 175, or a combination thereof. Locking mechanism 195 may be located at an interface between first outer casing 160 and second outer casing 180. For example, locking mechanism 195 may be located at an interface between tapered edge 161 of first outer casing 160 and interior edges 181a and 182a of second outer casing 180. In some aspects, locking mechanism 195 may include a latch or a pin securing first outer casing 160 to second outer casing 180. The latch or pin of locking mechanism 195 may be biased by a spring to release second handle member 175 from first handle member 155. Locking mechanism 195 may also include a sliding component, such as a switch, disposed at the bottom portion of bifurcated handle 145. The sliding component may be configured to exert a force on the spring after being moved from a resting position. In some aspects, based on receiving the force, the spring may displace the latch or pin configured to releasably couple second handle member 175 to first handle member 155. For example, the spring may rest at a coiled position and uncoil as the force is received by moving the sliding component. The uncoiled may displace the latch or pin. Accordingly, second handle member 175 may be released from first handle member 155. The force may be external to system 100, such as by a user.

In some other aspects, locking mechanism 195 may be disposed along bifurcated handle 145. Specifically, locking mechanism 195 may be disposed between a bottom portion and a top portion first handle member 155, second handle member 175, or a combination thereof. The sliding component of the locking mechanism, such as the switch, may be disposed between the bottom portion and top portion of first handle member 155, second handle member 175, or a combination thereof.

In some aspects, locking mechanism 195 may be operatively coupled to safety pin such that locking mechanism 195 actuates the spring to release the safety pin, for example, in response to the user moving the sliding component.

In some aspects, locking mechanism 195 or an additional locking member in second handle member 175 may be further configured to release the safety pin from the safety pin housing based on receiving an external force by a user. The force may release the spring from its resting position. Specifically, the spring may release from its coiled position to remove the safety pin from a shaft within the safety pin housing.

In some aspects, as shown in FIG. 3, blade sharpener 185 may be releasably secured within second handle member 175. For example, blade sharpener 185 may be releasably secured within second outer casing 180. If second handle member 175 pivots about the axis to the sliding position described in FIG. 2, a user may release blade sharpener 185 from second handle member 175. To release blade sharpener 185, second outer casing 180 may comprise of one or more springs disposed to a back portion of blade sharpener 185 such that the springs may release the housing of blade sharpener 185 based on the spring(s) being compressed by an external force, such as from a user. In some aspects, blade sharpener 185 may be released based on receiving a force perpendicularly directed away from second handle member 175.

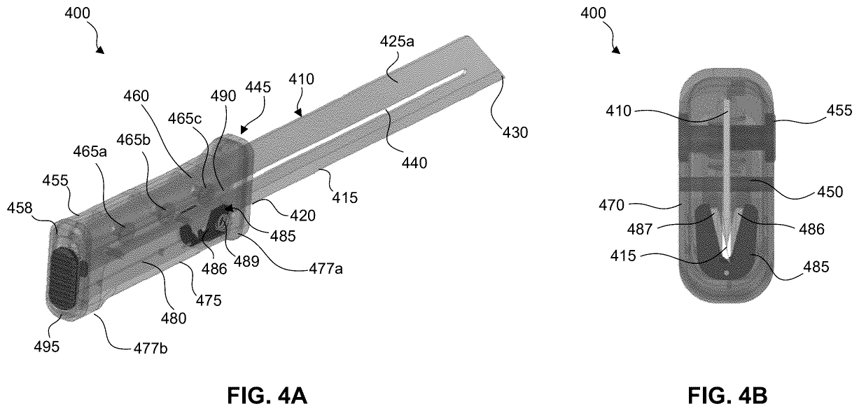

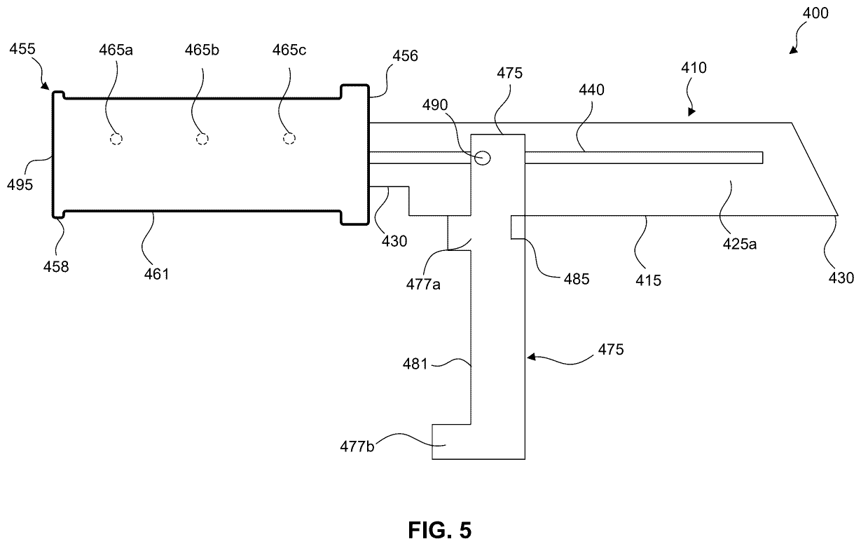

FIGS. 4A-5 illustrate an integrated cutting tool sharpening system 400 that includes a straight-bladed cutting tool, such as a blade 410, according to some aspects. Blade 410 may include a cutting edge 415, a base 420, a first side face 425a, a second side face 425b, and a tip 430. Cutting edge 415 may be straight without have any curvature. For example, cutting edge 415 may be straight from base 420 to tip 430. In some aspects, tip 430 may define a needle point, drop point, spear point, clip point, trailing point, or any other type of blade tip, as would be appreciated by one skilled in the art. Integrated cutting tool sharpening system 400 may include a guiding channel 440 disposed on at least one of first side face 425a and second side face 425b.

Integrating cutting tool sharpening system 400 may include a bifurcated handle 445 coupled to blade 410. In some aspects, bifurcated handle 450 may include a first handle member 455 and a second handle member 475. First handle member 455 may be fixed to base 420 of blade 410. In some aspects, first handle member 455 may include a first outer casing 460 that defines a slot at a distal end 458 of first handle member 455 to receive an upper portion of base 420 of blade 410. First outer casing 460 may be formed from a rigid material, such as plastic, resin, wood, steel, carbon fiber, titanium, fiberglass, or a comparable material used to fashion cutting tool handles as would be appreciated by one skilled in the art.

In some aspects, first handle member 455 may include one or more connecting shafts 465a, 465b, and 465c. For example, connecting shaft 465a may disposed inside of first outer casing 460 such that connecting shaft 465a secures first outer casing 455 to blade 410. Additionally, connecting shaft 465a may include a screw, a pin, or comparable fastener that extends transversely along the width of first outer casing 460 and through blade 410 such that first handle member 455 is fixed to blade 410.

In some aspects, second handle member 475 may be removably coupled to first handle member 455. Second handle member 475 may include second outer casing 480, blade sharpener 485, and guiding pin 490. Second outer casing 480 may be formed from a rigid material, such as plastic, resin, wood, steel, carbon fiber, titanium, fiberglass, or a comparable material used to form cutting tool handles, as would be appreciated by one skilled in the art. Second outer casing 480 may define a slot receiving a bottom portion of base 420 of blade 410. Second outer casing 480 may be disposed below first outer casing 460 such that a bottom edge 461 of first outer casing 460 is engaged with a top edge 481 of second outer casing 480. A back end of first outer casing 460 located at a proximal end 458 of first handle member 155 may be disposed flushed with a back end of second outer casing 480 located at a proximal end 478 of second handle member 175.

In some aspects, second handle member 475 may slide along blade 410 from a first position to a second position. The first position may refer to the position in which second handle member 475 is coupled to first handle member 455 at base 420. The second position may refer to a position in which second handle member 475 is disposed proximate to tip 430 of blade 410. In some aspects, the second position may refer to any position in which second handle member 475 is disposed on a portion of blade 410 and spatially separated from first handle member 450. Since different areas of cutting edge 415 may be prone to dulling faster over the course of use, sliding second handle member 475 across different areas of blade 410 may target portions of edge 415 that require additional sharpening.

In some aspects, second handle member 475 may include one or more handle lips 477, labelled collectively. Handle lips 477 may be disposed on a top portion and/or bottom portion of second handle member 475, such that a user's hand may be placed between edge 415 and the bottom portion of second handle member 475. For example, first handle lip 477a may be disposed at a top portion of second handle member 475 and second handle lip 477b may be disposed at a bottom portion of second handle member 475. Handle lips 477 may be incorporated into the shape of second outer casing 480.

In some aspects, integrated cutting tool sharpening system 400 may include blade sharpener 485. Blade sharpener 485 may further include a first sharpening blade 486 and a second sharpening blade 487 opposing the first sharpening blade 488. For example, the edges of first sharpening blade 486 and the second sharpening blade 487 may be arranged in a V-shaped formation to receive cutting edge 415 of blade 410 there between blade sharpener 485 may also include one or more sharpening springs that bias first sharpening blade 486 and second sharpening blade 487 towards each other. In some aspects, blade sharpener 485 may include a first sharpening spring 489 engaged against interior surface of second outer casing 480 and a back side of first sharpening blade 486 and a second sharpening spring engaged against interior surface of second outer casing 480 and a back side of second sharpening blade 487. In some aspects, blade sharpener 485 may include a housing that is received in second outer casing 480. For example, first sharpening blade 486, second sharpening blade 487, the sharpening spring(s), or a combination thereof may be received in the housing. Therefore, the spring(s) 489 may be engaged against the wall of the housing and a back side of first sharpening blade 486, second sharpening blade 487, or a combination thereof. Sharpening springs 489 bias the sharpening blades, individually or in combination, towards each other such that the angle between sharpening blades 486 and 487 of blade sharpener 485 may sharpen cutting edge 415 responsive to the sliding of second handle member 475 along blade 410.

In some aspects, blade sharpener 485 may be composed of a sharpening material. For example, first sharpening blade 486 and second sharpening blade 487 may be composed of tungsten steel or a comparable sharpening material, as would be appreciated by one skilled in the art. In some aspects, blade sharpener 485 may include one or more sharpening stones having a predetermined grit size and orientation with respect to edge 415. For example, the sharpening stones may be diamond-coated stones. In some aspects, the sharpening stones may be implemented with blade sharpener 485 in conjunction with or separately from first and second sharpening blades 486 and 487. The sharpening stones may have a range predetermined grit sizes. For example, the diamond-coated stones may have a grit size ranging from 200 grit to 1000 grit.

In some aspects, guiding channel 440 may resemble a concave groove along at least one of first side face 425a and second side face 425b of blade 410. For example, guiding channel 440 may define a first concave groove along first side face 425a and a second concave groove along second side face 425b. In some aspects, guiding channel 440 may define an opening extending through first side face 425a and second side face 425b. Second handle member 475 may be configured with guiding pin 490 to be received by guiding channel 440.

In some aspects, guiding pin 490 may be coupled to second outer casing 480 and slidably received in guiding channel 440. Accordingly, guiding pin 490 may be configured to slide along guiding channel 440 as second handle member 475 slides along blade 410. For example, when implemented with guiding channel 440 defining a hole through first and second side faces 425a and 425b of blade 410, guiding pin 490 may extend transversely through the opening of guiding channel 440 and across the width of second outer casing 480 such that a first end of guiding pin 190 is coupled to a first side of second outer casing 480 and a second end of guiding pin 490 is coupled to a second side of second outer casing 180 such that guiding pin 190 is slidably received in guiding channel 440. In some aspects, guiding pin 190 may be located in a front portion of second outer casing 480 proximate to a distal end 476 of second handle member 475. In another example, when implemented with guiding channel 440 defining the first concave groove on first side face 425a and a second concave groove on second side face 425b, guiding pin 490 may include a first pin received in the first concave groove of guiding channel 440 and a second pin received in the second concave groove of guiding channel 440, similar to guiding pin 190 described herein.

In some aspects, second handle member 475 may be configured to pivot about an axis defined by a pin, such as guiding pin 490, from the first position, where second handle member 475 is coupled to first handle member 455, to a sliding position, where at least a portion of second handle member 475, such as the back portion of second outer casing 480, is released from first handle member 455. For example, when disposed at the sliding position, second outer casing 480 of second handle member 475 may be configured to extend perpendicularly or obliquely with respect to first handle member 455. By pivoting toward a sliding position, the orientation of second outer casing 480 allows a user's hand to be positioned further away from blade 410 and permits the user to apply more force to second outer casing 480 of second handle member 475 during the sharpening process.

In some aspects, second handle member 475 may include a safety pin disposed within second outer casing 480. Safety pin may be received in a cavity defined in second outer casing 480. Safety pin may be biased, for example, by a spring, to lock second handle member 475 in the sliding position. If second handle member 475 reaches a specific orientation with respect to the first handle member 455 (e.g., the sliding position), the safety pin may lock second handle member 475 at the sliding position. In some aspects, safety pin may lock second handle member 475 if second handle member 475 pivots 90 degrees, 45 degrees, or any orientation configured by the user, from first handle member 455.

In some aspects, second handle member 475 may be configured to release from first handle member 455 and remain at an orientation parallel to cutting edge 415 as second handle member 475 slides from the first position to the second position. In doing so, second handle member 475 does not pivot when sliding from the first position to the second position. In such aspects, guiding pin 490 may orient second handle member 475 to remain parallel to edge 415 while sliding along blade 410.

In some aspects, system 400 may include a locking mechanism 495 disposed on at least one of first outer casing 460 of first handle member 455 and second outer casing 480 of second handle member 475. Locking mechanism 495 may be coupled to first handle member 455, second handle member 475, or a combination thereof. For example, locking mechanism 495 may be located at the proximal end of bifurcated handle 450, such as proximal end 158 of first handle member 155 and proximal end 178 of second handle member 175. In some aspects, locking mechanism 495 may include a latch or a pin securing first outer casing 460 to second outer casing 480. The latch or pin of locking mechanism 195 may be biased by a spring, such as an extension spring, to release second handle member 475 from first handle member 455. Locking mechanism 495 may include a sliding component, such as a switch, at the proximal end of bifurcated handle 445. The sliding component may be configured to exert a force on the spring after being moved from a resting position. The application of force exerted by the sliding component urges the spring to displace the latch or pin, thereby releasing second handle member 475 from first handle member 455. Accordingly, second handle member 475 may be released from first handle member 455 by the user actuating the sliding component.

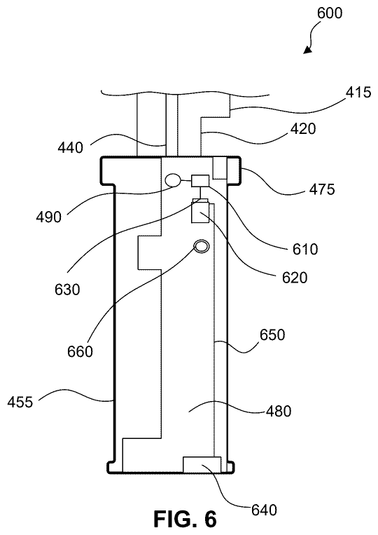

In some aspects, locking mechanism 495 may be disposed along bifurcated handle 445. Specifically, locking mechanism 495 may be disposed between a bottom portion and a top portion of first handle member 455, second handle member 475, or a combination thereof. Locking mechanism 495 may include a spring configured to release second handle member 475 coupled to first handle member 455 and/or first outer casing 460. FIG. 6 illustrates an automated sharpening system 600 of the integrated cutting tool sharpening system, according to some aspects. FIG. 6 shall be described with reference to FIGS. 4A and 4B, in which the elements contained therein are emphasized in greater detail. However, FIG. 6 is not limited to those example aspects.

In some aspects, second handle member 475 may include an automated sharpening system 600. For example, automated sharpening system 600 may be received inside of second outer casing 480. The components of automated sharpening system 600 may be received within an electrical housing inside of second outer casing 480. Automated sharpening system 600 may include a battery 620 and a motor 610 configured to receive power from battery 620. Motor 610 may propel second handle member 475 to slide from base 420 of blade 410 to a second position. The second position may be proximal to tip 430 or any position to which guiding channel 440 extends above base 420. In some aspects, motor 610 may also adjust the pressure applied to first and second sharpening blades 486 and 487 and/or spin sharpening stones of sharpener 485. In some aspects, automated sharpening system 600 may include a second motor operatively coupled to sharpening blades 486 and 487 and/or spin sharpening stones of blade sharpener 485 to adjust the pressure applied by sharpening blades 486 and 487 and/or the spin rate of sharpening stones of blade sharpener 485.

In some aspects, motor 610 may be configured to rotate a shaft coupled to a rotor of motor 610 at a predetermined speed. For example, the predetermined speed may be 10,000 revolutions per minute (RPM). Furthermore, motor 610 may be in electrical communication with battery 620 such that battery 620 provides power to motor 610. Battery 620 may operate at a predetermined voltage. For example, the predetermined voltage may be 12 volts. The shaft of motor 610 may be operatively coupled to a transmission set to translate rotational movement to linear movement of second handle member 175.

In some aspects, automated sharpening system 600 may further include controller 630. Controller 630 may be configured to be in the electrical communication with battery 620. In some aspects, controller 630 may be a microcontroller unit. In some aspects, controller 630 may include a processor and memory, including computer storage media in the form of volatile memory, such as Random Access Memory, and/or nonvolatile memory, such as Read Only Memory. In some embodiments, the memory of controller 630 may be configured to store computer readable instructions, data structures, program modules, and other data, which are inputted to the processor for the execution of operations, as described herein. The processor of controller 630 may be a special purpose or a general purpose processor device. As will be appreciated by persons skilled in the relevant art, the processor of controller 630 may also be a single processor in a multi-core/multiprocessor system, such system operating alone, or in a cluster of computing devices operating in a cluster or server farm. The processor of controller 630 is connected to a communication infrastructure, for example, a bus, message queue, network, or multi-core message-passing scheme.

In some aspects, controller 630 may control the speed of motor 610 to propel second handle member 475 at a predetermined rate, thereby providing a desirable sharpening effect for cutting edge 415 of blade 410. For example, controller 630 may adjust the rotation speed of motor 610 to perform a rough, a smooth, and refining sharpening operation. In some aspects, controller 630 may detect the condition of cutting edge 415 via a sensor and adjust the speed of motor 610 according to the detected condition. In some aspects, controller 630 may adjust the angle of the sharpening blades and/or stones by actuating an actuator or a motor configured to tilt the sharpening blades or stones at a predetermined angle. In some aspects, controller 630 may adjust the pressure applied to the sharpening blades or stones by actuating an actuator or motor configured to urge the sharpening blades or stones.

In some aspects, power button 660 may be disposed along bifurcated handle 445. For example, power button 660 may be disposed along second outer casing 480 of second handle member 475. Power button 660 may be in electrical communication with controller 630. Additionally, power button 660 may comprise a transducer configured to initiate a transmission of power between battery 620 and motor 610.

In some aspects, motor 610 may be configured to propel second handle member 475 to slide at the predetermined speed along guiding channel 440 from the first position (e.g., base 420) to the second position (e.g., tip 430). In some aspects, motor 610 may be configured to propel second handle member 475 to slide at the predetermined speed in a reverse direction from the second position (e.g., tip 430) to the first position (e.g., base 420). In some aspects, motor 610 may be configured to propel second handle member 475 in a reverse direction based on determining guiding pin 490 of second handle member 475 has reached the end of guiding channel 440. For example, controller 630 may determine that guiding pin 490 has reached the end of guiding channel 440. Controller 630 may make this determination by tracking the number of clock cycles from when power button 660 was pushed. Once this determination has been made by controller 630, controller 630 may slow motor 610 down to zero RPM before reversing the rotational direction of motor 610. The reversed rotational speed of motor 610 may be the aforementioned predetermined speed (e.g., 10,000 RPM).

In some aspects, automated sharpening system 600 may include charging port 640 and charging cable 650. Charging port 640 may be USB-C or a comparable charging configuration that would be appreciated by one skilled in the art. Charging port 640 may be electrically coupled with charging cable 650, such that power may be transmitted to automated sharpening system 600 to recharge battery 620.

It is to be appreciated that the Detailed Description section, and not the Summary and Abstract sections, is intended to be used to interpret the claims. The Summary and Abstract sections may set forth one or more but not all exemplary aspects of the present aspects as contemplated by the inventor(s), and thus, are not intended to limit the present aspects and the appended claims in any way.

The foregoing description of the specific aspects will so fully reveal the general nature of the aspects that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the claimed aspects should not be limited by any of the above-described exemplary aspects, but should be defined only in accordance with the claims and their equivalents.

What is claimed is:

1. An integrated cutting tool sharpening system, comprising:
a blade, wherein the blade comprises a cutting edge, a base, a tip, a first side face, and a second side face;
a guiding channel disposed along at least one of the first side face or the second side face; and
a bifurcated handle, wherein the bifurcated handle comprises:
a first handle member fixed to the base of the blade, wherein the first handle member comprises:
a first outer casing; and
one or more connecting shafts disposed inside the first outer casing, wherein the one or more connecting shafts secure the first outer casing to the blade;
a second handle member removably coupled to the first handle member and configured to slide along the blade from a first position, wherein the second handle member is coupled to the first handle member, to a second position, wherein the second handle member is disposed proximate to the tip of the blade, wherein the second handle member comprises:
a second outer casing;
a blade sharpener disposed in a front portion of the second handle member, wherein the blade sharpener is configured to engage the cutting edge of the blade as the second handle member slides along the blade; and
a guiding pin coupled to the second outer casing and slidably received in the guiding channel such that the guiding pin is configured to slide along the guiding channel as the second handle member slides along the blade; and
a locking mechanism disposed on at least one of the first outer casing or the second outer casing, wherein the locking mechanism is configured to releasably secure the second outer casing of the second handle member to the first outer casing of the first handle member.

2. The integrated cutting tool sharpening system of claim 1, wherein the blade sharpener comprises:
a first sharpening blade;
a second sharpening blade opposing the first sharpener blade; and
one or more sharpening springs biasing the first sharpening blade and the second sharpening blade towards each other,
wherein the first sharpening blade and the second sharpening blade are arranged to receive the cutting edge of the blade between the first sharpening blade and the second sharpening blade.

3. The integrated cutting tool sharpening system of claim 2, wherein the blade sharpener comprises:
a housing received in the second outer casing, wherein the first sharpening blade, the second sharpening blade, and the one or more sharpening springs are received in the housing such that the one or more springs are engaged against a wall of the housing and a back side of at least one of the first sharpening blade or the second sharpening blade.

4. The integrated cutting tool sharpening system of claim 1, wherein the guiding channel defines an opening extending through the first side face and the second side face.

5. The integrated cutting tool sharpening system of claim 1, wherein the guiding channel defines a first concave groove along the first side face and a second concave groove along the second side face of the blade.

6. The integrated cutting tool sharpening system of claim 1, wherein the cutting edge of the blade is straight and the guiding channel extends from the base of the blade to the tip of the blade.

7. The integrated cutting tool sharpening system of claim 6, further comprising:
a first handle lip on a top portion of the second handle member adjacent to the blade; and
a second handle lip on a bottom portion of the second handle member.

8. The integrated cutting tool sharpening system of claim 1, wherein the locking mechanism is disposed at a proximal end of the first handle member and further comprises:
a spring disposed in the first outer casing, the spring is configured to release the second handle member coupled to the first outer casing of the first handle member in response to receiving an application of force; and
a sliding component disposed at the proximal end of the first handle member, the sliding component is configured to slide from a resting position along the proximal end of the first handle member, thereby applying force on the spring to release the second outer casing of the second handle member from the first outer casing of the first handle member.

9. The integrated cutting tool sharpening system of claim 1, wherein the cutting edge of the blade is curved and a shape of the guiding channel corresponds to the curvature of the cutting edge to the tip of the blade.

10. The integrated cutting tool sharpening system of claim 1, wherein the second handle member further comprises:
an automated sharpening system disposed inside the second outer casing, wherein the automated sharpening system comprises:
a battery; and
a motor configured to receive power from the battery, wherein the motor is further configured to propel the second handle member to slide between the first and second positions.

11. The integrated cutting tool sharpening system of claim 10, wherein the automated sharpening system further comprises:
a controller in electrical communication with the battery; and
a power button in electrical communication with the microcontroller.

12. The integrated cutting tool sharpening system of claim 11, wherein the power button comprises a transducer configured to initiate power between the battery and the motor.

13. The integrated cutting tool sharpening system of claim 10, wherein the motor is further configured to propel the second handle member to slide at a predetermined speed along the guiding channel from the first position to the second position.

14. The integrated cutting tool sharpening system of claim 13, wherein the motor is configured to propel the second handle member to slide at the predetermined speed from the second position to the first position.

15. The integrated cutting tool sharpening system of claim 1, wherein the blade sharpener comprises at least one sharpening blade formed of tungsten steel.

16. The integrated cutting tool sharpening system of claim 1, wherein the blade sharpener comprises one or more diamond-coated stones having a predetermined grit size and a predetermined orientation with respect to the cutting edge of the blade.

17. The integrated cutting tool sharpening system of claim 16, wherein the predetermined grit size of the one or more diamond-coated stones is selected from a range of 200 grit to 1000 grit.

18. The integrated cutting tool sharpening system of claim 1, wherein the second handle member is configured to pivot about an axis defined by the guiding pin to a sliding position.

19. The integrating cutting tool sharpening system of claim 1, wherein the second handle member extends perpendicularly with respect to the first handle member when set in the sliding position.

20. The integrated cutting tool sharpening system of claim 18, further comprising:
a safety lock configured to lock the second handle member at the sliding position.
